(19) United States
(12) Patent Application Publication
(10) Pub. No.: US 2025/0117703 A1
(43) Pub. Date: Apr. 10, 2025

(54) MONITORING AI INFRASTRUCTURE

(71) Applicant: Jed Arkin, Gaithersburg, MD (US)

(72) Inventor: Jed Arkin, Gaithersburg, MD (US)

(21) Appl. No.: 18/901,862

(22) Filed: Sep. 30, 2024

Related U.S. Application Data
(60) Provisional application No. 63/588,733, filed on Oct. 8, 2023.

(30) Foreign Application Priority Data
Nov. 27, 2023 (GB) 2318075.5

(51) Int. Cl. G06N 20/00

(52) U.S. Cl. CPC G06N 20/00

(57) ABSTRACT

A system includes a communication interface and a processor. The processor is configured to identify a value of at least one feature of artificial intelligence (AI) infrastructure, to compare the value to a threshold that was defined responsively to a biological parameter, and in response to comparing the value to the threshold, to output, via the communication interface, an alert indicating that computational capabilities of the AI infrastructure are excessive. Other embodiments are also described.

### CROSS-REFERENCES TO RELATED APPLICATIONS

The present application claims the benefit of U.S. Provisional Patent Application No. 63/588,733 to Arkin, filed Oct. 8, 2023, entitled “Consciousness Limiting Device for AI,” whose disclosure is incorporated herein by reference, and the priority of UK Patent Application No. 2318075.5 to Arkin, filed Nov. 27, 2023, entitled “Monitoring AI infrastructure,” whose disclosure is incorporated herein by reference.

### FIELD OF THE INVENTION

The present invention is related to the field of artificial intelligence (AI).

### BACKGROUND OF THE INVENTION

AI systems are rapidly growing in complexity, with leading models now integrating not only billions of parameters, but also expansive networks of artificial neurons.

### SUMMARY OF THE INVENTION

The emergent sophistication of AI systems has prompted ethical concerns, including the concern that AI systems might attain a semblance of consciousness. Accordingly, there is an urgent need for precise guidelines to guide accountable AI evolution, and systems for enforcing these guidelines.

To address this urgent need, embodiments of the present invention provide a system comprising a communication interface and a processor. The processor is configured to identify a value of at least one feature of artificial intelligence (AI) infrastructure, such as the number of neurons in a neural network. The processor is further configured to compare the value to a predefined threshold, which in some embodiments, is based on a biological parameter such as an estimated number of neurons in a brain of a particular biological species. In response to comparing the value to the predefined threshold, the processor may output, via the communication interface, an alert indicating that the computational capabilities of the AI infrastructure are excessive.

There is therefore provided, in accordance with some embodiments of the present invention, a system, including a communication interface and a processor. The processor is configured to identify a value of at least one feature of artificial intelligence (AI) infrastructure, to compare the value to a predefined threshold, and in response to comparing the value to the predefined threshold, to output, via the communication interface, an alert indicating that computational capabilities of the AI infrastructure are excessive.

In some embodiments, the processor is a first processor, the system further includes a second processor and a real-time clock (RTC) configured to clock the second processor, and the second processor is configured to timestamp activities of, and synchronize with, the first processor, based on the RTC.

In some embodiments, the processor is configured to identify the value by programmatic inspection of the AI infrastructure.

In some embodiments, the AI infrastructure includes an AI model, and the processor is configured to identify the value by parsing code that defines the AI model.

In some embodiments, the processor is configured to identify the value by parsing documentation that documents the AI infrastructure.

In some embodiments, the processor is configured to identify the value by analyzing metadata associated with the AI infrastructure.

In some embodiments, the processor is configured to identify the value by parsing a configuration file that configures the AI infrastructure.

In some embodiments, the processor is further configured to generate and communicate a compliance report detailing a compliance of the AI infrastructure to predefined standards.

In some embodiments, the processor is further configured to timestamp the identifying of the value.

In some embodiments, the processor is further configured to define the threshold responsively to the biological parameter.

In some embodiments, the processor is configured to output the alert to an entity selected from the group of entities consisting of: a public blockchain, a governmental regulatory authority, a voluntary industry compliance body, a standard-setting authority, and shareholders of a company that owns the AI infrastructure.

In some embodiments, the threshold was predefined responsively to a biological parameter.

In some embodiments,
the AI infrastructure includes a neural network,
the feature includes a number of neurons in the neural network, and
the biological parameter is an estimated number of neurons in a brain of a particular biological species.

In some embodiments, the AI infrastructure includes a neural network.

In some embodiments, the feature includes a number of neurons in the neural network.

In some embodiments, the feature includes a total number of parameters in the neural network.

In some embodiments, the processor is further configured to select the predefined threshold, from among multiple predefined thresholds, based on an architecture of the neural network.

In some embodiments, the AI infrastructure includes an AI model, and the processor is further configured to select the predefined threshold, from among multiple predefined thresholds, based on an efficacy of training of the AI model.

In some embodiments, the AI infrastructure includes an AI model and a computer system configured to construct or execute the AI model.

In some embodiments, the processor is further configured to select the predefined threshold, from among multiple predefined thresholds, based on a task for which the AI model is executed.

In some embodiments, the processor is further configured to inhibit the construction or execution of the AI model in response to comparing the value to the predefined threshold.

In some embodiments, the processor is configured to inhibit the construction or execution of the AI model by shutting down a computer system that is constructing or executing the AI model.

In some embodiments, the feature includes a computational throughput of the computer system.

In some embodiments, the feature includes a processing speed of the computer system.

In some embodiments, the feature includes an amount of available or utilized memory of the computer system.

In some embodiments, the feature includes a storage capacity of the computer system.

In some embodiments, the feature includes an average duration of operations performed by the computer system.

In some embodiments, the computer system includes at least one environmental sensor, and the processor is further configured to monitor and report a status of the environmental sensor.

There is further provided, in accordance with some embodiments of the present invention, a method including identifying a value of at least one feature of artificial intelligence (AI) infrastructure, comparing the value to a predefined threshold, and in response to comparing the value to the predefined threshold, outputting an alert indicating that computational capabilities of the AI infrastructure are excessive.

There is further provided, in accordance with some embodiments of the present invention, a computer software product including a tangible non-transitory computer-readable medium in which program instructions are stored. The instructions, when read by a processor, cause the processor to identify a value of at least one feature of artificial intelligence (AI) infrastructure, to compare the value to a predefined threshold, and in response to comparing the value to the predefined threshold, to output an alert indicating that computational capabilities of the AI infrastructure are excessive.

The present invention will be more fully understood from the following detailed description of embodiments thereof, taken together with the drawings, in which:

### BRIEF DESCRIPTION OF THE DRAWINGS

FIG. 1 is a schematic illustration of a monitoring system for monitoring AI infrastructure, in accordance with some embodiments of the present invention;

FIG. 2 is a flow diagram for a method for monitoring AI infrastructure, in accordance with some embodiments of the present invention; and

FIG. 3 is a schematic illustration of a method for defining a threshold for limiting the computational capabilities of a neural network, in accordance with some embodiments of the present invention.

### DETAILED DESCRIPTION

### Overview

The emergent sophistication of AI systems has prompted ethical concerns, including the concern that AI systems might attain a semblance of consciousness. Notwithstanding these concerns, there exists a risk of a technological “arms race” among corporations, which would likely increase AI complexities even further, especially in terms of neuron counts and related parameters. Accordingly, there is an urgent need for precise guidelines to guide accountable AI evolution, and systems for enforcing these guidelines.

To address this urgent need, embodiments of the present invention provide a monitoring system configured to monitor one or more features of AI infrastructure, such as the size and/or sophistication of an AI model or the processing capabilities of a computer on which the AI model is implemented. In the event that the features indicate that the computational abilities of the AI infrastructure exceed predefined limits, the monitoring system communicates an alert to an appropriate external monitoring entity, such as a governmental regulatory entity.

The “hard problem” of consciousness, as coined by philosopher David Chalmers, refers to the challenge of explaining why and how subjective experiences arise from physical processes in the brain. This problem is particularly pertinent in the context of AI, as it raises significant difficulties in determining when, or even if, an AI system has achieved a state of consciousness akin to human experience. The crux of the issue lies in the fact that consciousness is inherently subjective and introspective, making it elusive to objective measurement or quantification. This poses a substantial obstacle in setting quantitative limitations on AI development to prevent an AI system from becoming conscious, with all the legal, moral and security implications that would likely entail.

To address this challenge, some embodiments base the limits on attributes of biological brains, such as mammalian brains. In particular, a parallel is drawn between the intricacies of AI models and the organic complexities of mammalian brains, especially those that showcase significant traits of general intelligence. The neuronal structures found in these brains have evolved over extensive periods, optimizing their functioning in the process. These naturally-evolved structures serve as a compass for setting limitations on AI models, underscoring the advantages of organic intelligence.

For context, the human brain, comprising roughly 86 billion neurons, is capable of a myriad of cognitive tasks, emotions, and decision-making. Similarly, the brains of mammals known for their intelligence, such as dolphins or elephants, exhibit patterns of efficiency and evolution-induced optimization. Given the absence of such evolutionary pressures in the context of AI, AI models would ostensibly need to significantly surpass these natural systems, in terms of neuronal count and other quantitative measures, to attain comparable general intelligence.

Hence, embodiments of the present invention not only monitor and limit parameters (e.g., neuronal parameters) in an AI system, but also discern the depth and potential of the system's capabilities, based on a biologically-grounded benchmark. While organic systems have been sculpted by the forces of evolution, AI lacks this evolutionary finesse. As a result, even if AI models could replicate the exact neuronal structures of an organic brain, they would very likely still fall short in mimicking organic intelligence's nuances, due to the absence of evolutionary refinement.

Accordingly, in some embodiments, known quantitative attributes of biological brains are used to set an upper limit on the machine analogues of such attributes, in order to prevent the emergence of general intelligence and/or apparent consciousness in an AI system.

By helping enforce limitations on an AI system as described herein, embodiments of the present invention help manage a tangible, quantifiable frontier for AI evolution, addressing ethical issues and possibly tempering a technological arms race, thus providing enterprises with a safe, specific, publicly-tenable and legislatively-defensible consensus boundary for AI development.

### System Description

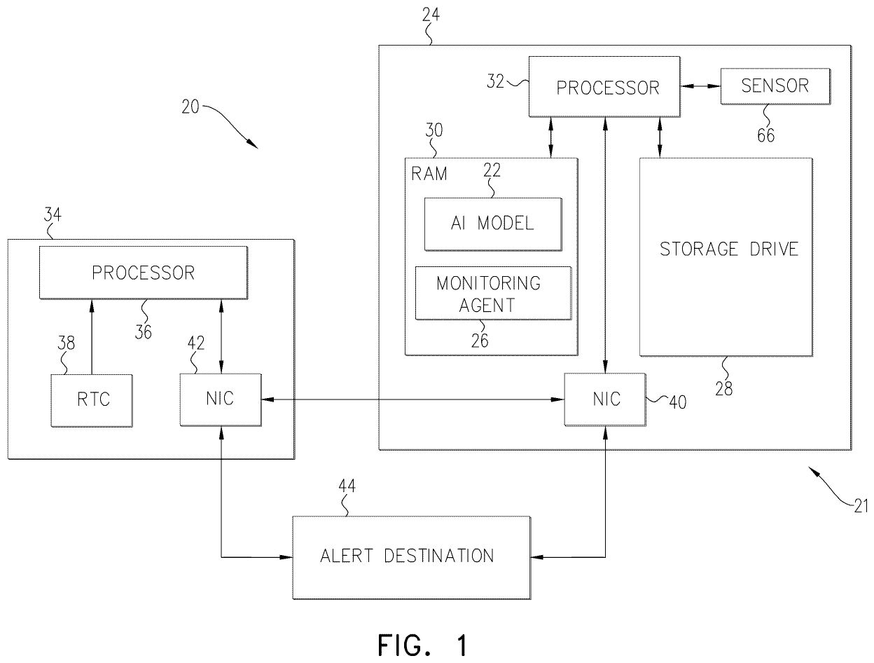

Reference is initially made to FIG. 1, which is a schematic illustration of a monitoring system 20 for monitoring AI infrastructure 21, in accordance with some embodiments of the present invention.

AI infrastructure 21 includes an AI model 22, which is typically defined in software code and, in some cases, includes a neural network. In some cases, the AI infrastructure further includes a computer system 24, comprising a single computer or multiple cooperatively-networked computers, configured to construct or to execute AI model 22. Typically, computer system 24 comprises a processor 32, a random access memory (RAM) 30, a storage drive 28 (e.g., a hard drive), and a communication interface 40, such as a network interface controller (NIC).

For example, processor 32 may load the AI model, from storage drive 28, into RAM 30, and then execute the AI model. Alternatively, by executing machine-learning code loaded into RAM 30, processor 32 may construct the AI model and then store it in storage drive 28.

System 20 comprises a monitoring agent 26, which is typically defined in software code. Monitoring agent 26 is loaded into RAM 30 and is then executed by processor 32. Alternatively, monitoring agent 26 is executed on a separate computer system. In some embodiments, system 20 further comprises a separate computing module 34 comprising a processor 36, such as a microcontroller, and a real-time clock (RTC) 38, which is configured to clock processor 36. Computing module 34 further comprises a communication interface 42, such as a NIC. Via communication interface 42 and communication interface 40, processor 36 interfaces with monitoring agent 26. For example, based on RTC 38, processor 36 may timestamp the activities of, and synchronize with, monitoring agent 26.

Monitoring agent 26 is configured to monitor AI infrastructure 21 so as to identify the value of at least one feature of the AI infrastructure. The monitoring agent is further configured to compare the value to a predefined threshold. In response to comparing the value to the predefined threshold, the monitoring agent, or processor 36, may output an alert indicating that the computational capabilities of the AI infrastructure are excessive. For example, the alert may be communicated, via communication interface 40 or communication interface 42, to an alert destination 44, such as a public blockchain, a governmental regulatory authority, a voluntary industry compliance body, a standard-setting authority, and/or shareholders of a company that owns the AI infrastructure.

In some cases, computer system 24 further includes at least one environmental sensor 66 including, for example, a visual sensor, an auditory sensor, and/or a chemical sensor. Processor 32 receives input from environmental sensor 66, and uses the input to enhance the performance of AI model 22. In some embodiments, monitoring agent 26 is further configured to monitor the status of the environmental sensor and to report the status (e.g., via communication interface 40) separately from or together with any alerts.

In general, each of processor 32 and processor 36 may be embodied as a single processor, or as a cooperatively networked or clustered set of processors. The functionality of the processor may be implemented solely in hardware, e.g., using one or more fixed-function or general-purpose integrated circuits, Application-Specific Integrated Circuits (ASICs), and/or Field-Programmable Gate Arrays (FPGAs). Alternatively, this functionality may be implemented at least partly in software. For example, the processor may be embodied as a programmed processor comprising, for example, a central processing unit (CPU) and/or a Graphics Processing Unit (GPU). Program code, including software programs, and/or data may be loaded for execution and processing by the CPU and/or GPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

### Monitoring the AI Infrastructure

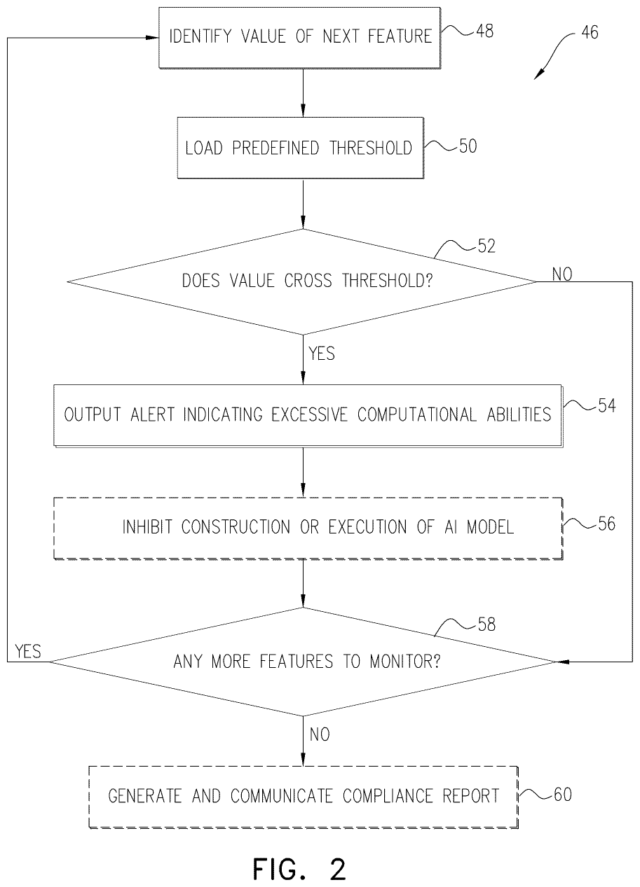

Reference is now made to FIG. 2, which is a flow diagram for a method 46 for monitoring AI infrastructure, in accordance with some embodiments of the present invention. Method 46 is performed by monitoring agent 26 (FIG. 1), optionally cooperatively with processor 36.

Method 46 begins with a value-identifying step 48, at which the monitoring agent identifies the value of a feature of the AI infrastructure. For example, for cases in which the AI infrastructure includes a neural network, the feature may include the number of neurons in the neural network, the number of layers (or the number of hidden layers) in the neural network, the number of connections (or “synapses”) between neurons, or the total number of parameters in the neural network. Alternatively, for example, the feature may include the computational throughput of computer system 24 (FIG. 1), which may be measured, for example, in floating point operations per second (FLOPS). Alternatively, for example, the feature may include the processing speed of the computer system, which may be measured, for example, in GHz. Alternatively, for example, the feature may include the amount of available or utilized memory of the computer system, e.g., the amount of RAM 30 (FIG. 1) that is available or utilized, which may be measured, for example, in megabytes (MB). Alternatively, for example, the feature may include the storage capacity of the computer system, e.g., the amount of available space in storage drive 28 (FIG. 1), which may be measured, for example, in gigabytes (GB) or terabytes (TB). Alternatively, for example, the feature may include the average duration of operations performed by the computer system, which may be measured, for example, in nanoseconds.

In some embodiments, to identify the value of the feature (e.g., the number of neurons in a neural network), the monitoring agent parses code that defines AI model 22 (FIG. 1), parses documentation that documents the AI infrastructure or a configuration file that configures the AI infrastructure, or analyzes metadata associated with the AI infrastructure. (In such embodiments, the monitoring agent need not necessarily run on, or monitor, computer system 24.) In some embodiments, to perform this parsing or analysis, the monitoring agent uses natural language processing (NLP) or pattern-recognition techniques. An example of a configuration file that configures AI infrastructure is a JavaScript Object Notation (JSON) or YAML file, which defines a neural architecture.

Alternatively, the monitoring agent uses auditing or logging functionality, such as network-inventory functionality, to identify the value of a feature of computer system 24 or of AI model 22 (FIG. 1). For example, the monitoring agent may identify the processing speed (or “capacity”) of processor 32 (measured in GHz, for example). As another example, while the AI model is being constructed or executed, the monitoring agent may identify an amount of RAM 30 (measured in GB, for example) that is occupied or available, or a parameter count (e.g., a neuron count) for the AI model.

In some embodiments, the monitoring agent identifies the value of the feature by programmatic inspection of the AI infrastructure. For example, the monitoring agent may scan the AI model to identify the number and configuration of parameters thereof, such as parameters relating to the architecture of a neural network or the weights and biases within the neurons of the network. (Such an inspection may be performed dynamically, and may be more comprehensive than a general software inspection.) As another example, the monitoring agent may evaluate the performance of computer system 24, e.g., so as to ascertain the computational efficiency or resource utilization of the system.

Following value-identifying step 48, at a threshold-loading step 50, the monitoring agent loads a predefined threshold for the feature. The monitoring agent then checks whether the identified feature value crosses the threshold, at a comparing step 52. In other words, at comparing step 52, the monitoring agent checks whether the identified feature value is greater than or less than the threshold, depending on whether the feature is correlated or inversely correlated to the computational abilities of the AI infrastructure. For example, if the feature is the number of neurons in the AI model, the monitoring agent may check whether the identified feature value exceeds the threshold.

If the predefined threshold is crossed, the monitoring agent, at an alert-outputting step 54, outputs an alert indicating that the computational abilities of the AI infrastructure are excessive. As described above with reference to FIG. 1, this alert may be outputted, for example, to a public blockchain, a governmental regulatory authority, a voluntary industry compliance body, a standard-setting authority, or shareholders of a company that owns the AI infrastructure. Subsequently, at an optional inhibiting step 56, the monitoring agent inhibits construction or execution of the AI model, e.g., by shutting down computer system 24. Subsequently, or if the threshold is not crossed, the monitoring agent checks, at another checking step 58, whether any more features are to be monitored. If yes, the monitoring agent returns to value-identifying step 48. Otherwise, the monitoring agent (e.g., an embedded reporting module belonging to the monitoring agent) executes an optional reporting step 60, at which the monitoring agent generates and communicates a compliance report detailing the compliance of the AI infrastructure to the relevant predefined standards. For example, after encrypting the report, the report may be communicated to a public blockchain, a governmental regulatory authority, a voluntary industry compliance body, a standard-setting authority, or shareholders of a company that owns the AI infrastructure.

In some embodiments, the monitoring agent timestamps the identifying of the value at value-identifying step 48 along with any other monitoring activities, e.g., based on RTC 38 (FIG. 1). The timestamps are included in the compliance report.

In some embodiments, at threshold-loading step 50, the monitoring agent selects the threshold from among multiple predefined thresholds. For example, separate thresholds may be defined for different tasks, and the monitoring agent may select the threshold based on the task for which the AI model is executed. As a specific example, for a large language model (LLM), the threshold for a language-generation task may be different from the threshold for a classification task, given that the LLM is more efficient at language generation. (For example, the threshold number of neurons may be lower for the language-generation task.) Alternatively, for example, separate thresholds may be defined for different neural-network architectures, and—assuming the AI model includes a neural network—the monitoring agent may select the threshold based on the architecture of the neural network. As a specific example, the threshold for a transformer architecture may be different from the threshold for older architectures, given the greater efficiency of a transformer architecture. Alternatively, for example, separate thresholds may be defined for different training efficacies, and the monitoring agent may select the threshold based on the efficacy of training of the AI model. As a specific example, the threshold may be different for a model trained on higher-quality data, on a greater volume of data, and/or using more advanced techniques (e.g., regularization or optimization), relative to a model trained on lower-quality data, on less data, and/or using less advanced techniques.

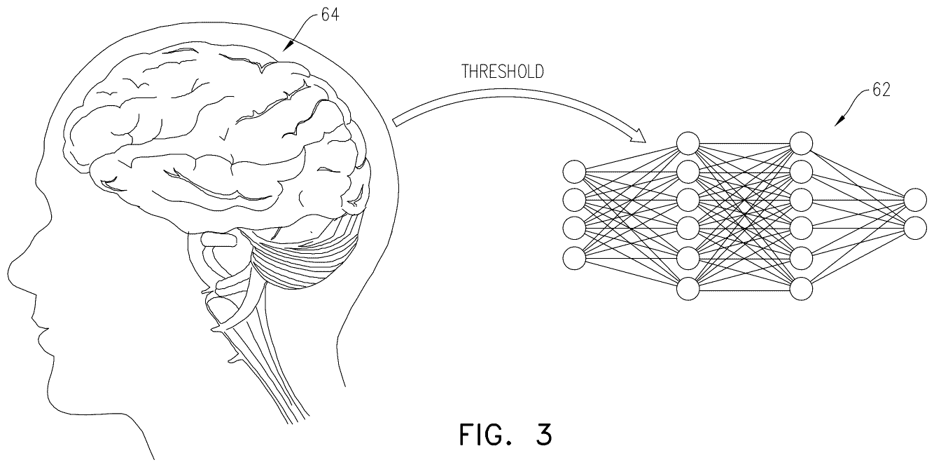

Reference is now made to FIG. 3, which is a schematic illustration of a method for defining a threshold for limiting the computational capabilities of a neural network 62, in accordance with some embodiments of the present invention.

Typically, the thresholds for the AI model, such as neural network 62, are predefined by processor 32 (FIG. 1), processor 36, or another processor, responsively to a biological parameter, such as a parameter of a brain 64 of a particular biological species, such as a mammalian (e.g., human) brain. For example, a threshold number of neurons or synapses in neural network 62 may be defined responsively to an estimated (i.e., approximate) number of neurons or synapses in brain 64, such as a predefined multiple or fraction of this estimate.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A system, comprising:
a communication interface; and
a processor, configured to:
identify a value of at least one feature of artificial intelligence (AI) infrastructure,
compare the value to a threshold that was defined responsively to a biological parameter, and
in response to comparing the value to the threshold, output, via the communication interface, an alert indicating that computational capabilities of the AI infrastructure are excessive.

2. The system according to claim 1,
wherein the processor is a first processor,
wherein the system further comprises a second processor and a real-time clock (RTC) configured to clock the second processor, and
wherein the second processor is configured to timestamp activities of, and synchronize with, the first processor, based on the RTC.

3. The system according to claim 1, wherein the processor is configured to identify the value by programmatic inspection of the AI infrastructure.

4. The system according to claim 1, wherein the AI infrastructure includes an AI model, and wherein the processor is configured to identify the value by parsing code that defines the AI model.

5. The system according to claim 1, wherein the processor is configured to identify the value by parsing documentation that documents the AI infrastructure.

6. The system according to claim 1, wherein the processor is configured to identify the value by analyzing metadata associated with the AI infrastructure.

7. The system according to claim 1, wherein the processor is configured to identify the value by parsing a configuration file that configures the AI infrastructure.

8. The system according to claim 1, wherein the processor is further configured to generate and communicate a compliance report detailing a compliance of the AI infrastructure to predefined standards.

9. The system according to claim 1, wherein the processor is further configured to define the threshold responsively to the biological parameter.

10. The system according to claim 1, wherein the processor is configured to output the alert to an entity selected from the group of entities consisting of: a public blockchain, a governmental regulatory authority, a voluntary industry compliance body, a standard-setting authority, and shareholders of a company that owns the AI infrastructure.

11. The system according to claim 1,
wherein the AI infrastructure includes a neural network,
wherein the feature includes a number of neurons in the neural network, and
wherein the biological parameter is an estimated number of neurons in a brain of a particular biological species.

12. The system according to claim 1, wherein the AI infrastructure includes a neural network.

13. The system according to claim 12, wherein the feature includes a number of neurons in the neural network.

14. The system according to claim 12, wherein the feature includes a total number of parameters in the neural network.

15. The system according to claim 12, wherein the processor is further configured to select the threshold, from among multiple predefined thresholds, based on an architecture of the neural network.

16. The system according to claim 1, wherein the AI infrastructure includes an AI model, and wherein the processor is further configured to select the threshold, from among multiple predefined thresholds, based on an efficacy of training of the AI model.

17. The system according to claim 1, wherein the AI infrastructure includes an AI model and a computer system configured to construct or execute the AI model.

18. The system according to claim 17, wherein the processor is further configured to select the threshold, from among multiple predefined thresholds, based on a task for which the AI model is executed.

19. The system according to claim 17, wherein the processor is further configured to inhibit the construction or execution of the AI model in response to comparing the value to the threshold.

20. The system according to claim 19, wherein the processor is configured to inhibit the construction or execution of the AI model by shutting down a computer system that is constructing or executing the AI model.

21. The system according to claim 17, wherein the feature includes a computational throughput of the computer system.

22. The system according to claim 17, wherein the feature includes a processing speed of the computer system.

23. The system according to claim 17, wherein the feature includes an amount of available or utilized memory of the computer system.

24. The system according to claim 17, wherein the feature includes a storage capacity of the computer system.

25. The system according to claim 17, wherein the feature includes an average duration of operations performed by the computer system.

26. A method, comprising:
identifying a value of at least one feature of artificial intelligence (AI) infrastructure;
comparing the value to a threshold that was defined responsively to a biological parameter; and
in response to comparing the value to the threshold, outputting an alert indicating that computational capabilities of the AI infrastructure are excessive.

27. A computer software product comprising a tangible non-transitory computer-readable medium in which program instructions are stored, which instructions, when read by a processor, cause the processor to:
identify a value of at least one feature of artificial intelligence (AI) infrastructure,
compare the value to a threshold that was defined responsively to a biological parameter, and
in response to comparing the value to the threshold, output an alert indicating that computational capabilities of the AI infrastructure are excessive.
